(19) United States
(12) Patent Application Publication
(10) Pub. No.: US 2004/0182489 A1
(43) Pub. Date: Sep. 23, 2004

(54) Wheel structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/388,433

(22) Filed: Mar. 17, 2003

(51) Int. Cl. B60C 15/02

(52) U.S. Cl. 152/383

(57) ABSTRACT

A wheel structure is generally composed of a wheel frame and a tire. The wheel frame is a combination of a male frame and a female frame, wherein outer surfaces of the male and female frames are formed with ridges and the center portions of which are formed with locating holes. The male frame is formed with a rib having an extension, and a plurality of locating blocks protruding from an inner wall of a trough of the male frame. The female frame also has a plurality of locating grooves corresponding to the locating blocks of the male frame. The tire is made of plastics foam material having an opening at the center and a reduced section near the opening. The tire is sleeved onto the male frame and confined by the rib, and the female frame is engaged with the male frame by the locating blocks meshing with the locating grooves, as well as fasteners to secure the tire on the wheel frame.

### FIELD OF THE INVENTION

This invention relates to a wheel structure applied to a scooter, a tricycle, and a baby stroller, and more particularly, to a wheel frame sleeved with a foam tire, which is lighter in weight and more durable.

### BACKGROUND OF THE INVENTION

Conventional wheels are formed with foam material integral to a wheel frame. This forms a tight connection with the wheel frame, however, this design is in solid state and has more weight. Later a design uses an inner hollow EVA foam wheel structure, wherein an inner edge of the wheel secured to an outer ridge of the wheel frame. The inner center portion of the tire has a circular groove, and the wheel frame comprises a dented ridge with protuberances corresponding to the hollow section, the outer ridge of the wheel frame also has a locating ridge to secure the wheel at place, and to save material of the wheel.

However, this design comprises a number of shortcomings, one of which is the tire has to be pulled in order to install on the wheel frame.

### SUMMARY OF THE INVENTION

It is the primary object of the present invention to provide a wheel structure, which is lighter in weight and more reliable.

It is another object of the present invention to provide a wheel structure, which is safer to users.

It is a further object of the present invention to provide a wheel structure, which is inexpensive in manufacture.

### BRIEF DESCRIPTION OF THE DRAWINGS

FIG. 1 is an exploded view of the present invention, and

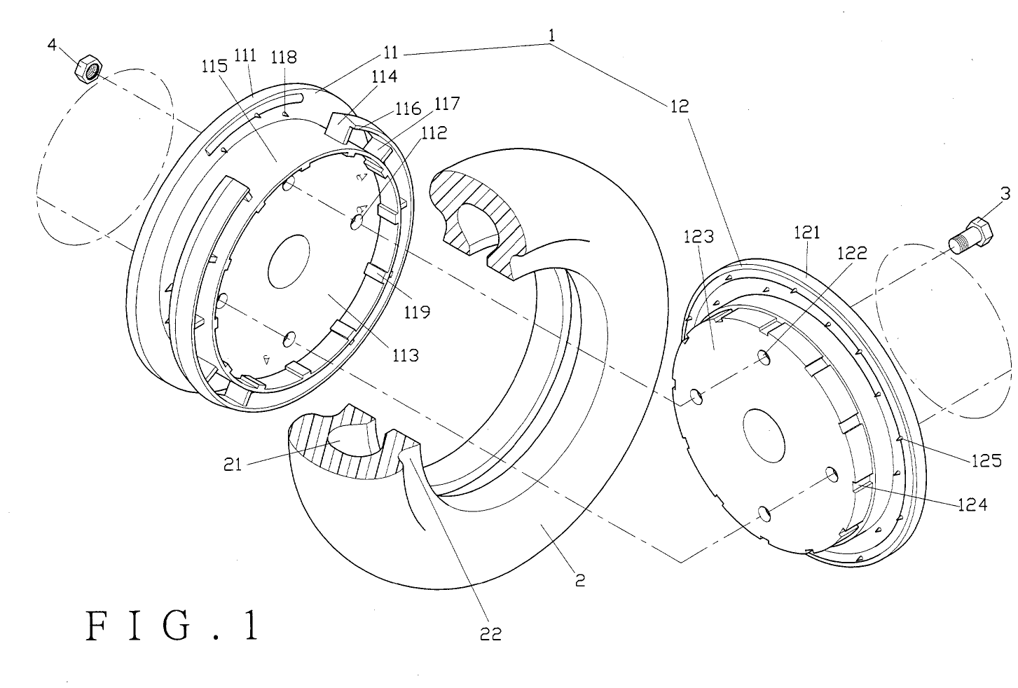

FIG. 2 is a cross-sectional view of the present invention.

### DETAILED DESCRIPTION OF THE PREFERRED EMBODIMENT

The present invention comprises a wheel frame 1, and a tire 2.

The wheel frame 1 comprises a male frame 11 and a female frame 12. Both the frames 11 and 12 have a ridge 111 and 121 protruding upwardly from one end thereof, and a plurality of locating holes 112 and 122 on the center portion. The male frame 11 has a trough 113 on the end opposing the ridge 111 and a rib 114 protruding upwardly around a circumferential portion of the male frame 11 with a notch 115. The rib 114 has an extension section 116 at one end, which is supported by a plurality of reinforcement ribs 117. The ridge 111 of the male frame 11 is formed with a plurality of corns 118 corresponding to the notch 115. The inner wall of the trough 113 extrudes a plurality of locating blocks 119 equally spaced from each other. The female frame 12 has an inner wall 123 protruding from one end corresponding to the trough 113 with a plurality of locating grooves 124 corresponding to the locating blocks 119 of the male frame 11, and also comprises a plurality of corns 125 on the ridge 121.

The tire 2 is made of plastics foam material having an opening 21 at the center and a reduced section 22 near the opening 21.

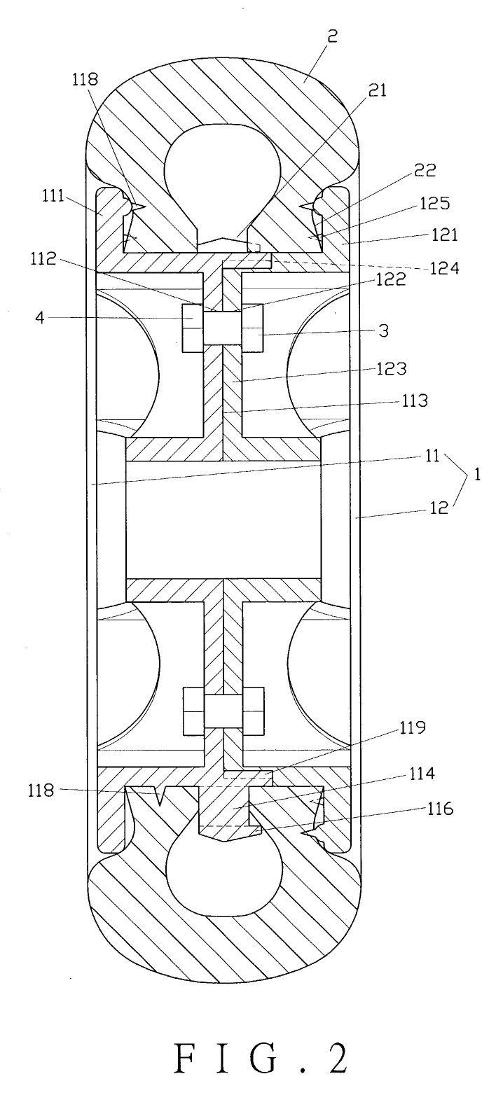

To assemble the present invention, as shown in FIG. 2, the tire 2 is sleeved onto the male frame 11 through the notch 115 of the rib 114 to sleeve in first, and follow the trace to sleeve the entire tire 2 onto the male frame 1, and to clamp on the corns 118 on the ridge 111 whereas the rib 114 is to engage with the tire 2. The extension section 116, at this moment, engages with an inner edge of the tire 2. The female frame 12 is placed into the male frame 11 with the locating grooves 124 meshing with the locating blocks 119, and bolts 3 are inserted through the locating holes 112 and 122 of the male frame 11 and female 12 and fastened with nuts 4 from the other end to form an entire wheel. The reduced section 22 of the tire 2 is clamped between the ridges 111 and 121 of the male frame 11 and the female frame 12 and is confined by the corns 118 and 125, thus the tire 2 is held on the wheel frame 1 securely.

I claim:

1. A wheel structure comprising a wheel frame and a tire,
said wheel frame comprising a pair of male frame and a female frame, both said frames having a ridge protruding upwardly from one end thereof and a plurality of locating holes at a center portion, said male frame having a trough on one end opposing said ridge and extending a rib upwardly around a circumferential portion of said male frame with a notch, said rib having an extension section at one end which is supported by a plurality of reinforcement ribs, said ridge of said male frame being formed with a plurality of corns corresponding to said notch, an inner wall of said trough extruding a plurality of locating blocks equally spaced from each other; said female frame having an inner wall protruding from one end corresponding to said trough of said male frame with a plurality of locating grooves corresponding to said locating blocks of said male frame, and further comprising a plurality of corns on said ridge,
said tire being made of plastics foam material with a reduced section near a center opening,
said tire being sleeved onto said male frame with said rib engaging with two sides of said opening of said tire, and said extension section of said rib engaging with an inner edge of said tire to hold said tire secured to said male frame, said tire being confined by said rib, said female frame being inserted into said male frame with said locating grooves engaging with said locating blocks, and bolts being inserted through said locating holes of said female frame and said male frame and secured with nuts, thus said tire being confined by said corns of said frames and secured onto said wheel frame.
